(19) United States
(12) Patent Application Publication
(10) Pub. No.: US 2009/0179827 A1
(43) Pub. Date: Jul. 16, 2009

(54) High Brightness Large Screen Projected Displays using LCoS Image Generators

(76) Inventor: William S. Oakley, San Jose, CA (US)

Correspondence Address: TIPS GROUP;c/o Intellevate LLC, P. O. BOX 52050, Minneapolis, MN, 55402, US

(21) Appl. No.: 12/015,500

(22) Filed: Jan. 16, 2008

(51) Int. Cl. G09G 3/20; G03B 21/14; G03B 21/16

(52) U.S. Cl. 345/55; 353/30; 353/20

(57) ABSTRACT

In an embodiment, a system is provided. The system includes a housing. The system further includes a first LCoS assembly coupled to the housing. The system also includes a second LCoS assembly coupled to the housing. The system further includes a third LCoS assembly coupled to the housing. Additionally, the system includes a first beam splitter and a second beam splitter both coupled to the housing. The first beam splitter is arranged to split incoming light between the first LCoS assembly and the second beam splitter. The second beam splitter is arranged to split incoming light between the second LCoS assembly and the third LCoS assembly. The system also includes a first beam recombiner and a second beam recombiner both coupled to the housing. The first beam recombiner is arranged to receive light from the first LCoS assembly and the second LCoS assembly. The second beam recombiner is arranged to receive light from the first beam recombiner and from the third LCoS assembly. The system also includes a first light source to provide incoming light to the first beam splitter. The system further includes an output optics element coupled to the housing and arranged to receive light from the second beam recombiner and to focus an output light source.

### BACKGROUND

Projection of motion pictures in theatres is still primarily done based on film and projection technology little changed since the dawn of motion pictures. However, compared to film, digital media allows for much easier storage of representations of an image. In order to move beyond film-based projection, it would be useful to provide a digital projector which fits general theater requirements.

Furthermore, a consortium of studios has set forth a standard for future digital projection systems. While this standard is by no means final, it provides a rough guide as to what a system must do—what specifications must be met. Thus, it may be useful to provide a digital projection system which meets the standards of the studio consortium.

### BRIEF DESCRIPTION OF THE DRAWINGS

The present invention is illustrated by way of example in the accompanying drawings. The drawings should be understood as illustrative rather than limiting.

FIG. 1 illustrates an embodiment of an LCoS image projector.

FIG. 2 illustrates transmission characteristics of dichroic mirrors.

FIG. 3 illustrates alignment aspects of the embodiment of FIG. 1.

FIG. 4 illustrates cooling assemblies associated with the embodiment of FIG. 1.

FIG. 5 illustrates another embodiment of an LCoS image projector.

FIG. 6 illustrates an embodiment of an LCoS chip assembly with a TEC mounted thereto.

FIG. 7 illustrates cooling in embodiments such as those of FIGS. 1 and 5.

FIG. 8 illustrates an embodiment of a computer which may be used with the projectors of FIGS. 1 and 5, for example.

FIG. 9 illustrates an embodiment of a system using a computer and a projector.

FIG. 10 illustrates an embodiment of a network which may be used with various embodiments of the projectors and associated computers.

FIGS. 11A and 11B illustrate an embodiment of a complex polarizing beamsplitter which may be used with the embodiment of FIG. 5, for example.

### DETAILED DESCRIPTION

A system, method and apparatus is provided for a high brightness display. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

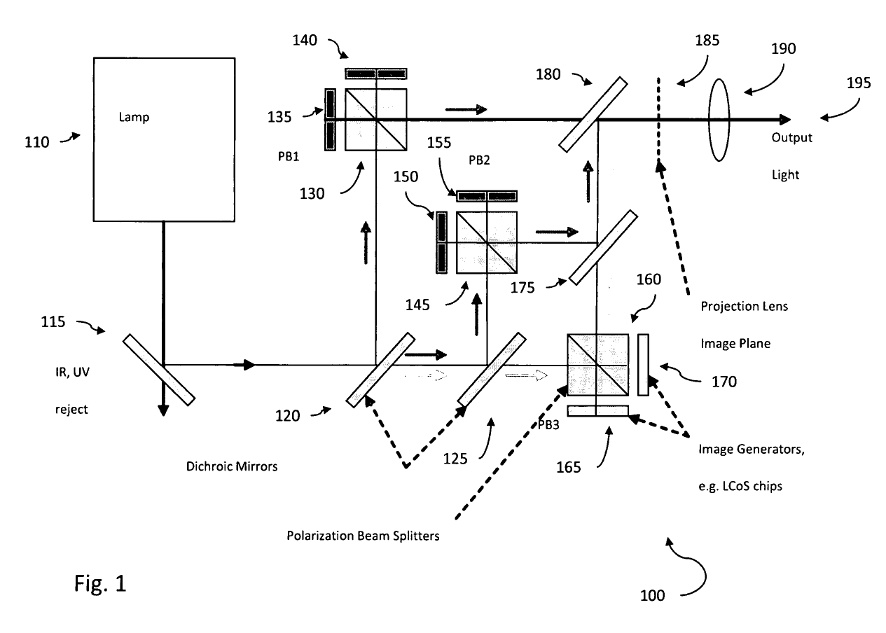

A high efficiency optical design for three color RGB (red, green, blue) image projectors is shown in FIG. 1 that uses six LCoS image planes to obtain both optical polarizations in all colors and is suitable for slide or dynamic video presentations to large screens. A randomly polarized white light source (110) is stripped of IR and UV components by an IR/UV rejection filter (115) input to a first dichroic mirror (DM1-120) which reflects the blue portion of the spectrum to a polarizing beam splitter (PB1-130). The remainder of the spectrum passes through the dichroic mirror (120) to a second dichroic mirror (DM2-125), which reflects the red portion of the spectrum to a second polarizing beam splitter (PB2-145). The remaining spectrum passes to a third polarizing beam splitter (PB3-160).

Each of the three beam splitters separates its portion of the spectrum into two orthogonal polarization components, each of which is directed to an active LCoS (Liquid Crystal on Silicon) image generation plane (chips 135, 140, 150, 155, 165 and 170). Both polarization components are selectively polarization rotated on a pixel by pixel basis by an electrical signal applied to the LCoS display chips, so as to modulate the input light and impart an image onto the throughput light. Polarization modulated light is reflected from each LCoS chip back through the polarizing beam splitters (130, 145 and 160), so that both polarizations exit from the polarizing beam splitter and are re-combined with similarly processed light of the other spectral portions via dichroic mirrors (175 and 180) to form a white image (at projection lens image plane 185) which is focused on a remote screen using a projection lens (190) to provide output light 195.

Application of a voltage to an LCoS chip pixel that is insufficient for 90 degree rotation of the optical polarization results in a smaller rotation of the plane of polarization for a beam reflected from an LCoS chip. On passing back (of the beam) through the polarizing beam splitter the rotated beam is split into two orthogonal polarized components of different intensities that exit the beam splitter in different directions. Thus the intensity of the output beam is reduced in proportion to the degree of polarization rotation (i.e. voltage on the pixel), and the unrotated portion is returned along its entrance path back toward the source.

Although many optical projection systems have been designed, multicolor displays using reflective LCoS image generation chips, one design the inventor is aware of is not well suited to large high brightness displays. The LCoS image generation devices employ a liquid crystal layer sandwiched between a transparent optical surface and a silicon electronic chip which applies a voltage to the liquid crystal layer on a pixel by pixel basis, causing spatially localized polarization rotation of light and thereby enabling an image to be imparted to light input through the transparent surface and reflecting back from the chip surface. The LCoS devices are universally employed in a reflective mode where the reflected light contains the image information.

The above referenced design uses four beam splitting cubes and several color absorption filters. It suffers from a low light efficiency as the input light is first split into two polarizations, each of which is then passed through color filters. This implementation causes half of the polarized light to be absorbed in the color filters. The absorbed light significantly heats the filters, trapping the heat between the polarizing cubes. Consequently this design, although compact, is only compatible with low intensity light, perhaps small fractions of a watt. A large screen multi-media display must be capable of transmitting several hundred watts of light, with potentially tens of watts absorbed in the image generating chips.

In contrast the proposed optical design implementation first separates the input light on a spectral basis, blue, red, then green light, using color separating dichroic mirrors, and each color is then input to its own polarizing beam splitter which directs polarized light to two LCoS image planes, one for each light polarization state. The light is thus spread over six separate LCoS chips. The reflected output images from the three beam splitters each contain both optical polarizations for their respective color, and the colored images are then re-combined using dichroic mirrors. By this means no light is absorbed in color filters and the system is capable of much higher optical power throughput as the dichroic mirrors absorb comparatively little light, and each color path is very efficient with minimal light loss at the LCoS planes. The LCoS image chips are accessible from the rear (the non-image side) and active chip cooling may therefore be employed to maintain each chip within a preferable operating temperature range.

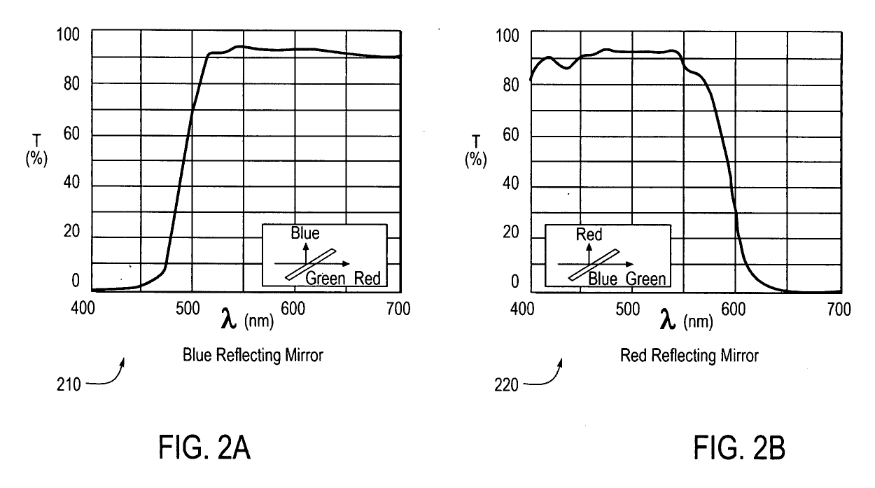

In one embodiment, the blue light is first separated using a blue reflecting, red and green transmitting dichroic mirror. Blue light is separated first as, for a maximum brightness display, it can least tolerate optical power losses, and some red and green light is lost at the blue reflecting dichroic mirror. Next the red light is separated as this is less tolerant to loss than the green portion of the spectrum. Reflection spectra of typical dichroic mirrors are shown in FIG. 2, with FIG. 2A showing a blue reflecting dichroic mirror and FIG. 2B showing a red reflecting dichroic mirror.

After passing through their respective LCoS image planes each color is recombined using dichroic mirrors similar to those used in the initial color separation process. It is noted the two re-combining dichroic mirrors are very angle sensitive as rotations will move the image planes out of registration. In an embodiment, the optical path lengths from the optical source to each LCoS image plane is essentially the same to enable essentially the same illumination fill factor and pattern to be obtained for each image plane. Similarly the three output colored images from the LCoS are all essentially equidistant from the projection lens, thereby enabling all images to be projected in focus.

The three images are typically combined in the image plane of the projection lens enabling existing projection lenses to be used. The images from the LCoS image generation chips are relayed to the projection lens image plane using standard relay lens techniques to maximize light throughput. The optical paths are arranged so that a single set of relay optics relays the image from each LCoS chip to the projector lens image plane. The relay optics is configured so the magnification from the LCoS image chips to the output image plane matches the output image plane format.

The basic optical system of FIG. 1 lies in a plane in some embodiments, which minimizes the number of optical elements, thereby minimizing scattered light and maintaining maximum image contrast. Each beam splitting cube is mounted on the same surface and all optical paths are co-planer. This facilitates fabrication and optical alignment. The co-planar layout also facilitates thermal control of the LCoS image generators as ‘through the support-plate’ airflow in a direction perpendicular to the plane of the optical system is easily configured and keeps the cooling air away from the optical path, reducing the possibility of optical artifacts created by air turbulence.

The LCoS image projector may use existing projection display components such as lamp hoses and associated power supplies, and available projection lenses. Both lamp houses and projection lenses are typically close to the image plane in film projectors. The light output from the lamp house is therefore relayed to the LCoS image chips by illumination relay optics with a magnification that matches the lamp output area to the image chip area.

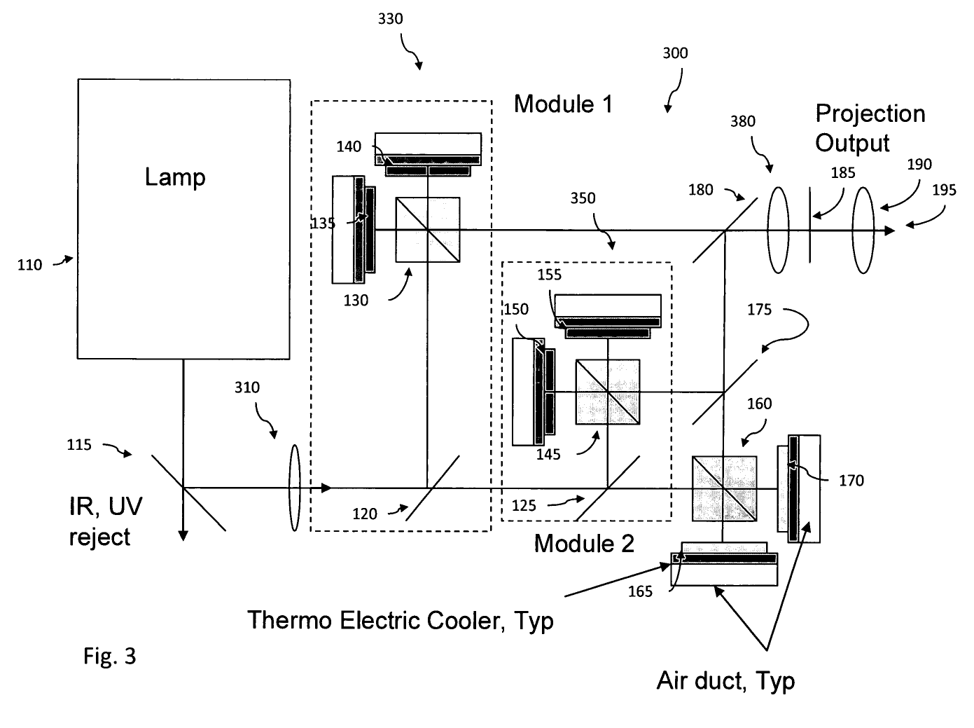

In some embodiments, the two LCoS image chips for each beam splitter may be aligned during initial assembly into a module which includes the dichroic mirrors, and locates each chip on axis, precision aligned in rotation about that axis, and optically equidistant from the output face of the beam splitter as shown by the dotted lines in FIG. 3. With all three modules in nominal position, the green module is focused to the output image plane, followed by focusing the red and then blue modules by translating the modules parallel to the input/output optical axes.

Thus, FIG. 3 illustrates the various modules which may be translated together for alignment/focusing purposes. A focusing optic 310 may be provided as needed. Module 330 includes dichroic mirror 120, beam splitter 130, and LCoS chip assemblies 135 and 140. Module 350 includes dichroic mirror 125, beam splitter 145, and LCoS chip assemblies 150 and 155. Note that the chip assemblies are shown with thermoelectric coolers and air plenums in this illustration.

Beam splitter 160 and associated components may be positioned as needed for focus/transmission purposes. Then, module 1 (330) may be translated to align beam splitter 130 (and corresponding optics) with dichroic mirror 180. Similarly, module 2 (350) may then be translated to align beam splitter 145 with dichroic mirror 175.

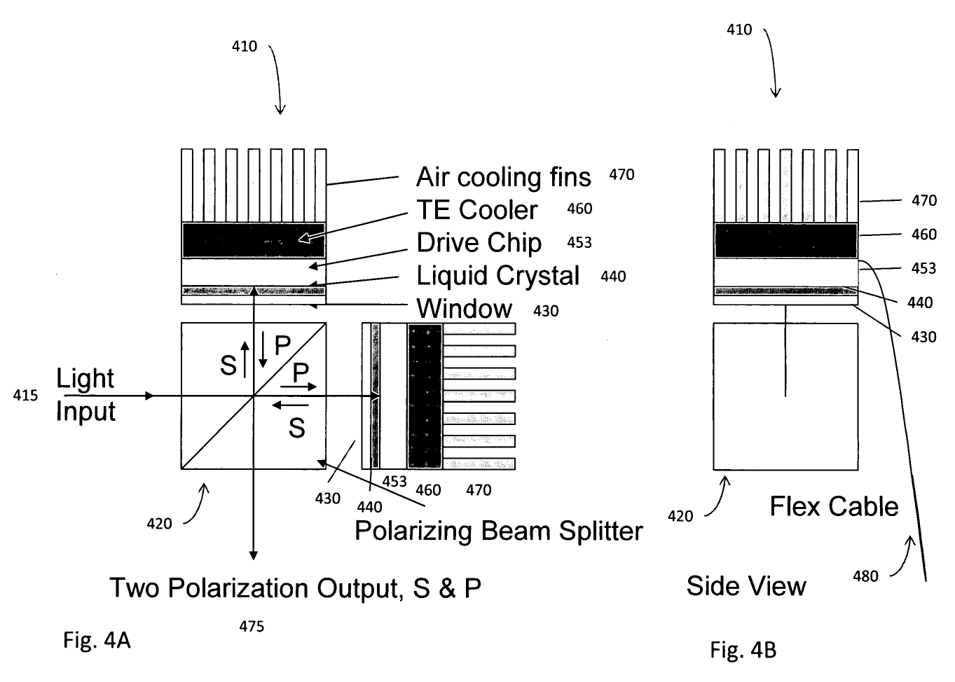

For high brightness displays it is desirable to pass as much optical energy through the system as possible. The limiting factor may well be the ability of the LCoS image generators to absorb heat as they are typically limited to an operating temperature range of 40-75 C. Each LCoS chip consumes several hundred milliwatts of electrical power. It is therefore potentially beneficial to add temperature control to each LCoS image chip as this will allow greater light power input and also eliminate any issue with differential expansion of the different image planes and provide cooling for the LCoS driver chip. In one embodiment, each LCoS chip is mounted on a Thermo-Electric Cooler (TEC) as in FIG. 4, with the cooling airflow directed into the page.

Thus, FIG. 4 illustrates cooling assemblies associated with the embodiment of FIG. 1. Assembly 410 includes a beam splitter 420, windows 430, liquid crystal 440, LCoS drive chips 450, TE coolers 460 and air cooling fins 470. The stack of window 430, liquid crystal 440, LCoS drive chip 450, TE cooler 460 and air cooling fins 470 provide a cooled LCoS assembly. Along with beam splitter 420, input light 415 is then transformed by this assembly into output light 475.

The TEC generates a temperature differential between two opposite faces and requires the TEC hot side be cooled by a flow of air or liquid. The air cooled configuration in FIG. 3 shows two LCoS chips per color and provides the ability to modulate the two different polarizations of an un-polarized colored beam. The ability to put images on a screen with two orthogonal optical polarizations facilitates simple implementation of 3D imagery, although viewers need to wear polarization discriminating eyewear.

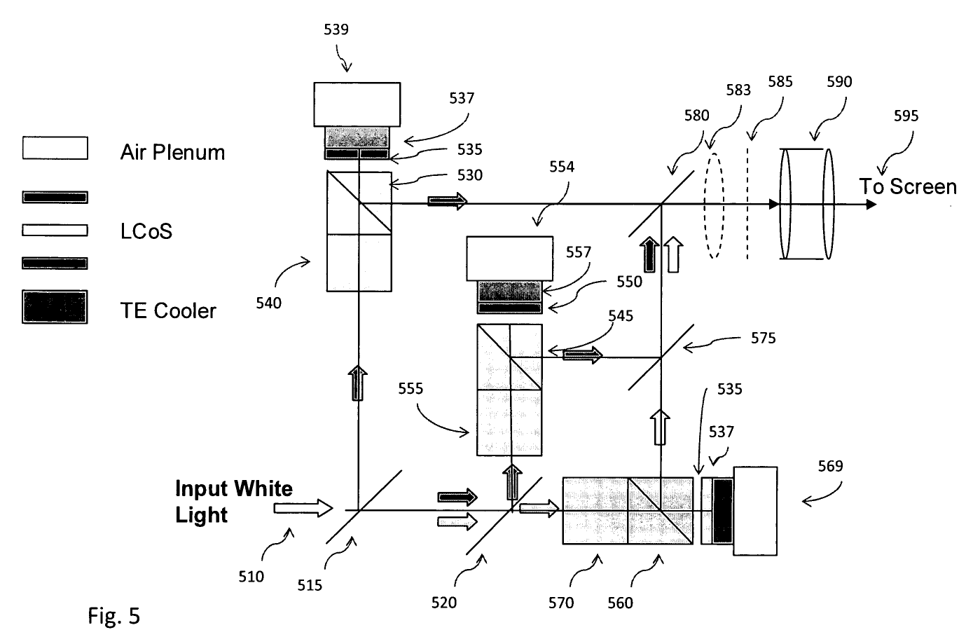

In an embodiment using polarization combining optics to reduce the number of LCoS image chips to three as shown in FIG. 5, one may provide a projection system with fewer LCoS chips.

Thus, FIG. 5 provides an illustration of another embodiment of an LCoS image projector. A randomly polarized white light source (510) is stripped of IR and UV components by an IR/UV rejection filter (515) input to a first dichroic mirror (515) which reflects the blue portion of the spectrum to a prism 540 that converts the entire beam to the same polarization by means of a half-wave plate and passes it to a polarizing beam splitter (530). The remainder of the spectrum passes through the dichroic mirror (515) to a second dichroic mirror (520), which reflects the red portion of the spectrum to a second polarization combining prism 555 and polarizing beam splitter (545). The remaining spectrum passes to a third polarization combining prism 570 and polarizing beam splitter (560).

Each of the three beam splitters separates its portion of the spectrum into two orthogonal polarization components, one of which is directed to an active LCoS (Liquid Crystal on Silicon) image generation plane (chips 535, 550 and 565). Both polarization components are selectively polarization rotated on a pixel by pixel basis by an electrical signal applied to the LCoS display chips, so as to modulate the input light and impart an image onto the throughput light. Polarization modulated light is reflected from each LCoS chip back through the polarizing beam splitters (530, 545 and 560), so that both polarizations exit from the polarizing beam splitter and are re-combined with similarly processed light of the other spectral portions via dichroic mirrors (575 and 580) to form a white image (at projection lens image plane 585) which is focused on a remote screen using a projection optics (590) to provide output light 595. Focusing to plane 585 may involve additional optics 583. Furthermore, each of LCoS chips 535, 550 and 565 are provided with a TEC (537, 552 and 567 respectively) and associated air plenum (539, 554 and 568 respectively) to provide cooling.

The optical design as in FIG. 1 lends itself to fabrication in a plane so multiple projectors are easily mounted side by side in close proximity. In such embodiments, cooling air flow to each LCoS is perpendicular to the plane of the optics, e.g. into the page, and does not pass through the optical path.

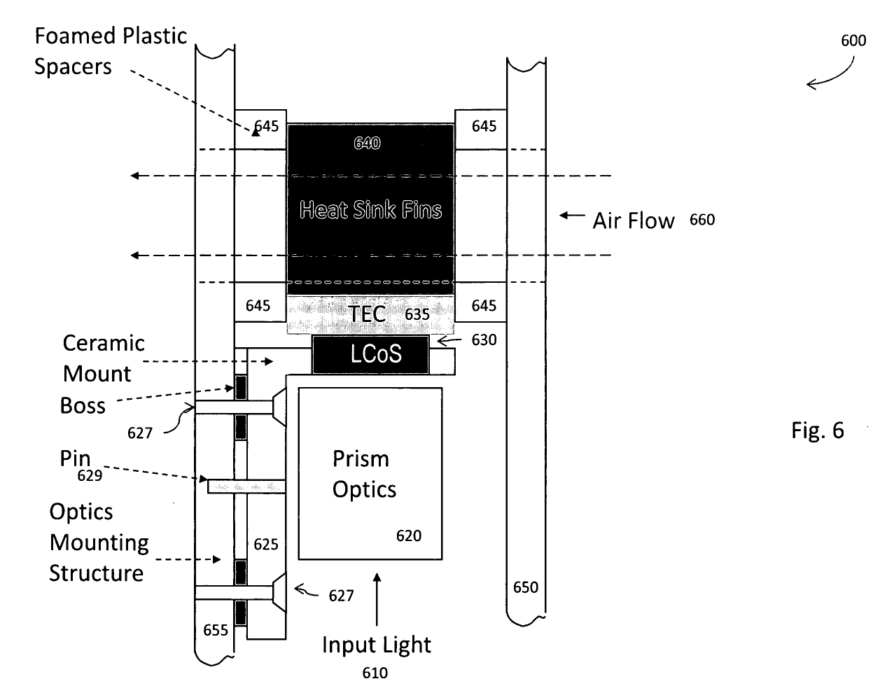

The TE cooler/LCoS chip assembly is mounted to the optical plate by bonding it into a ceramic holder with adhesive, so the ceramic thermally isolates the assembly from the main structure as in FIG. 6. The polarizing optics which passes light to and from the LCoS image chip is also mounted on the ceramic holder to minimize any thermal drift between it and the LCoS chip. The ceramic holder is mounted to the optical base structure via machined bosses in three locations which define a plane, and rotation and translation in the plane are prevented by a pair of stainless steel pins.

Thus, FIG. 6 illustrates an embodiment of an LCoS chip assembly with a TEC mounted thereto. Input light 610 passes through polarizing beam splitter 620 to LCoS chip 630. TEC 635 is mounted thereto to provide cooling. Heat sink fins 640 allow heat to be radiated into airflow 660. TEC635 and associated heat sink fins 640 are mounted to side walls 655 and 650 using foamed plastic spacers 645. LCoS chip 630 is mounted to ceramic mount 625, which is connected or coupled to wall 655 using machined bosses 631, fasteners 627 and pin 629.

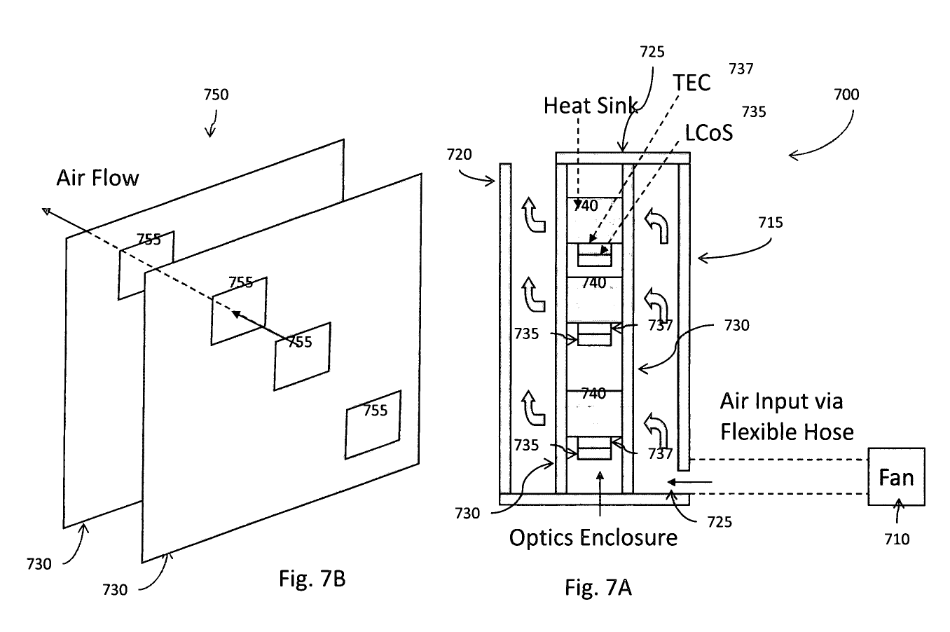

In an embodiment, the optical system is configured vertically with the TECs and heat sinks well apart from the optical path. The optics are located between two vertical plates in a dust free enclosure with the cooling air that passes over the finned heat sink passing between the plates in a confined region as shown in FIG. 7B. To maintain the maximum projected image resolution on the screen it is preferable to minimize vibration of the optical system so the cooling air is passed into the air plenum via a flexible connecting hose, as is further illustrated in FIG. 7A. The cooling air for the projection lamp is similarly passed into the lamp-house through a flexible hose for the same reason.

Thus, FIG. 7 illustrates cooling in embodiments such as those of FIGS. 1 and 5. FIG. 7A illustrates a side view of the cooling system, and FIG. 7B illustrates a perspective view of the cooling system in embodiments such as those of FIGS. 1 and 5. System 700 includes external housing walls 725 and 730, forming a housing with (cooling) air input and output openings. Internal walls 730 support the optics of the system. Mounted to internal walls 730 are three sets of an LCoS chip 735, TEC 737 and air fins 740. Fan 710 provides air input to the system to cool the air fins 740, and thus the TECs 737 and LCoS chips 735. The perspective view of FIG. 7B shows that apertures 755 provide for cooling air flow through support walls 730 to the air fins 740. These apertures 755 may be formed such that they do not cross the optical paths of the corresponding LCoS chips, thereby reducing artifacts from thermal variations in the air of the projector.

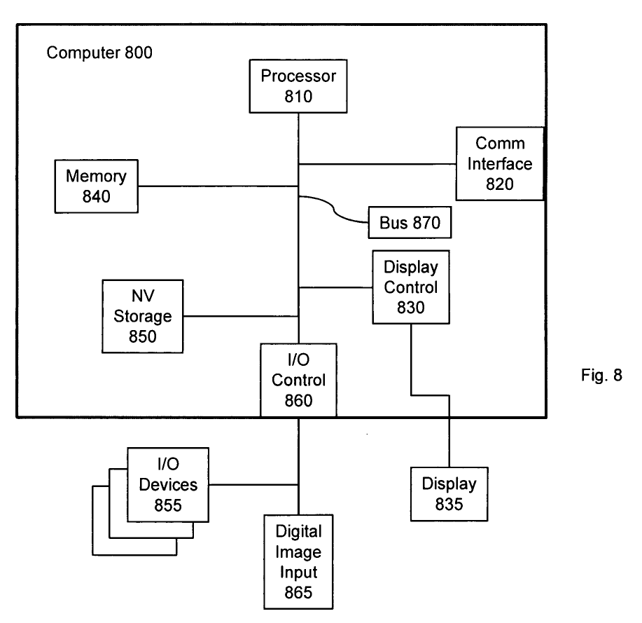

FIG. 8 illustrates an embodiment of a computer which may be used with the projectors of FIGS. 1 and 5, for example. The following description of FIG. 8 is intended to provide an overview of computer hardware and other operating components suitable for performing the methods of the invention described above and hereafter, but is not intended to limit the applicable environments. Similarly, the computer hardware and other operating components may be suitable as part of the apparatuses and systems of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 8 shows one example of a conventional computer system that can be used as a client computer system or a server computer system or as a web server system. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems. In the case of a closed network, a hardwired physical network may be preferred for added security.

The computer system 800 includes a processor 810, which can be a conventional microprocessor such as microprocessors available from Intel or Motorola. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). Display controller 830 can, in some embodiments, also control a projector such as those illustrated in FIGS. 1 and 5, for example. The input/output devices 855 can include a keyboard, disk drives, printers, a scanner, and other input and output devices, including a mouse or other pointing device. The input/output devices may also include a projector such as those in FIGS. 1 and 5, which may be addressed as an output device, rather than as a display. The display controller 830 and the I/O controller 860 can be implemented with conventional well known technology. A digital image input device 865 can be a digital camera which is coupled to an i/o controller 860 in order to allow images from the digital camera to be input into the computer system 800. Digital image data may be provided from other sources, such as portable media (e.g. FLASH drives or DVD media).

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows(r) from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

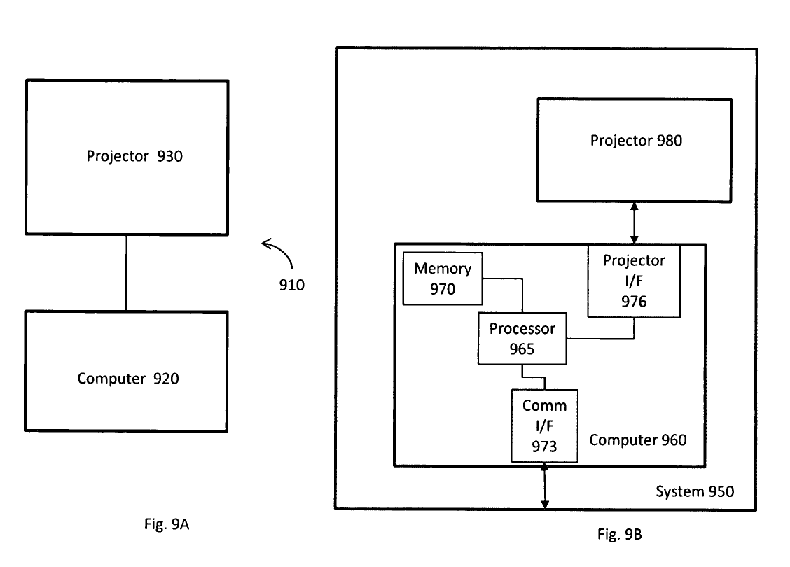

FIG. 9A illustrates an embodiment of a system using a computer and a projector. System 910 includes a conventional computer 920 coupled to a digital projector 930. Thus, computer 920 can control projector 930, providing essentially instantaneous image data from memory in computer 920 to projector 930. Projector 930 can use the provided image data to determine which pixels of included LCoS display chips are used to project an image. Additionally, computer 920 may monitor conditions of projector 930, and may initiate active control to shut down an overheating component or to initiate startup commands for projector 930.

FIG. 9B illustrates another embodiment of a system using a computer and projector. System 950 includes computer subsystem 960 and optical subsystem 980 as an integrated system. Computer 960 is essentially a conventional computer with a processor 965, memory 970, an external communications interface 973 and a projector communications interface 976.

The external communications interface 973 may use a proprietary (a standard developed for such a device but not publicized by its developer), or a publicly available communications standard, and may be used to receive both digital image data and commands from a user. The projector communications interface 976 provides for communication with projector subsystem 980, allowing for control of LCoS chips (not shown) included in projector subsystem 980, for example. Thus, projector communications interface 976 may be implemented with cables coupled to LCoS chips, or with other communications technology (e.g. wires or traces on a printed circuit board) coupled to included LCoS chips. Other components of computer subsystem 960, such as dedicated user input and output modules, may be included, depending on the needs for functionality of a conventional computer system in system 950. System 950 may be used as an integrated, standalone system—thus allowing for the possibility that each theater may use its own projector with a built-in control system, for example.

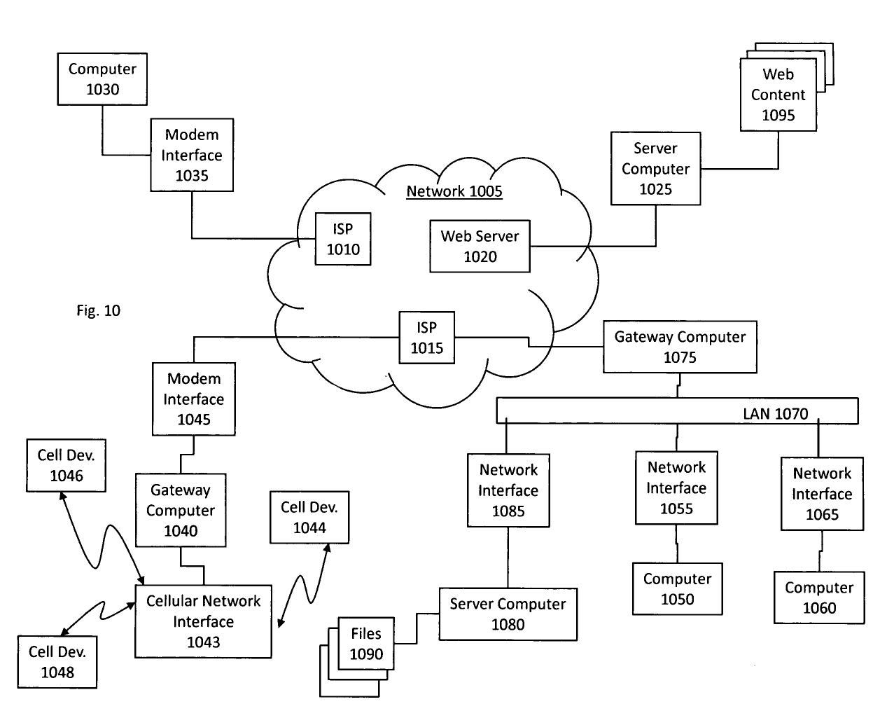

It may be useful to provide network services for a projection system. FIG. 10 shows an embodiment of several computer systems that are coupled together through a network 1005, such as the internet The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 1005 is typically provided by internet service providers (ISP), such as the ISPs 1010 and 1015. Users on client systems, such as client computer systems 1030, 1040, 1050, and 1060 obtain access to the internet through the internet service providers, such as ISPs 1010 and 1015. Access to the internet allows users of the client computer systems to exchange information, receive and send e-mails, and view documents, such as documents which have been prepared in the HTML format. These documents are often provided by web servers, such as web server 1020 which is considered to be “on” the internet. Often these web servers are provided by the ISPs, such as ISP 1010, although a computer system can be set up and connected to the internet without that system also being an ISP.

The web server 1020 is typically at least one computer system which operates as a server computer system and is configured to operate with the protocols of the world wide web and is coupled to the internet. Optionally, the web server 1020 can be part of an ISP which provides access to the internet for client systems. The web server 1020 is shown coupled to the server computer system 1025 which itself is coupled to web content 1095, which can be considered a form of a media database. While two computer systems 1020 and 1025 are shown in FIG. 10, the web server system 1020 and the server computer system 1025 can be one computer system having different software components providing the web server functionality and the server functionality provided by the server computer system 1025 which will be described further below.

Client computer systems 1030, 1040, 1050, and 1060 can each, with the appropriate web browsing software, view HTML pages provided by the web server 1020. The ISP 1010 provides internet connectivity to the client computer system 1030 through the modem interface 1035 which can be considered part of the client computer system 1030. The client computer system can be a personal computer system, a network computer, a web tv system, or other such computer system.

Similarly, the ISP 1015 provides internet connectivity for client systems 1040, 1050, and 1060, although as shown in FIG. 10, the connections are not the same for these three computer systems. Client computer system 1040 is coupled through a modem interface 1045 while client computer systems 1050 and 1060 are part of a LAN. While FIG. 10 shows the interfaces 1035 and 1045 as generically as a “modem,” each of these interfaces can be an analog modem, isdn modem, cable modem, satellite transmission interface (e.g. “direct PC”), or other interfaces for coupling a computer system to other computer systems.

Client computer systems 1050 and 1060 are coupled to a LAN 1070 through network interfaces 1055 and 1065, which can be ethernet network or other network interfaces. The LAN 1070 is also coupled to a gateway computer system 1075 which can provide firewall and other internet related services for the local area network. This gateway computer system 1075 is coupled to the ISP 1015 to provide internet connectivity to the client computer systems 1050 and 1060. The gateway computer system 1075 can be a conventional server computer system. Also, the web server system 1020 can be a conventional server computer system.

Alternatively, a server computer system 1080 can be directly coupled to the LAN 1070 through a network interface 1085 to provide files 1090 and other services to the clients 1050, 1060, without the need to connect to the internet through the gateway system 1075.

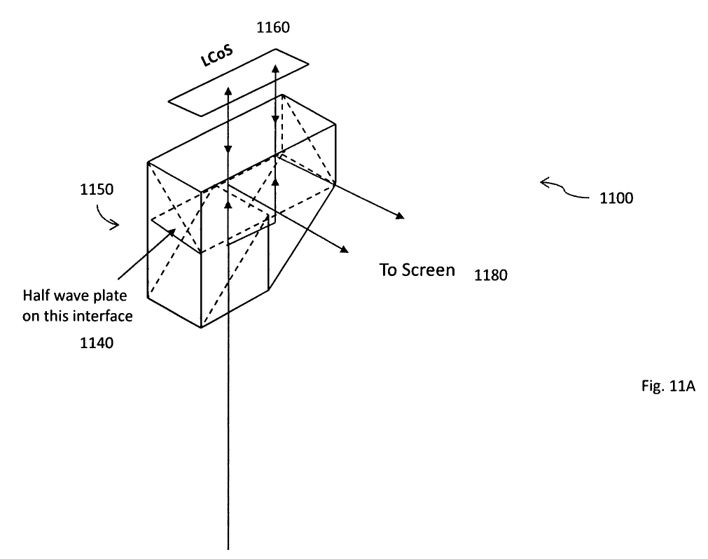

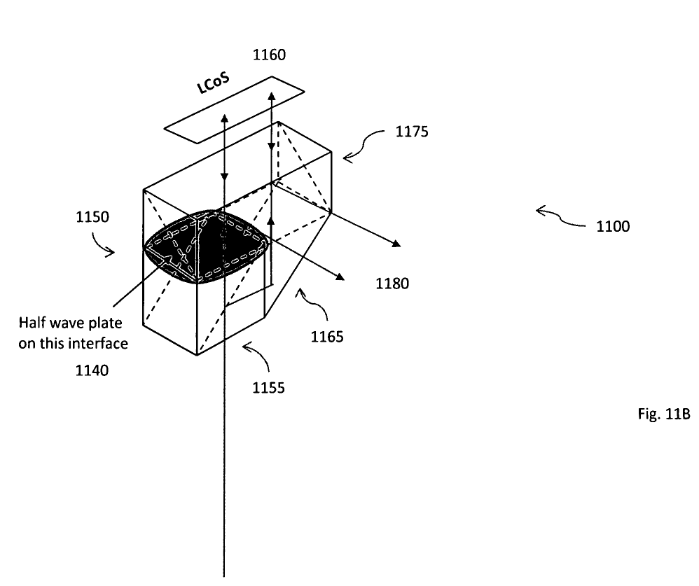

At least one of the optical elements discussed previously bears further discussion. FIGS. 11A and 11B illustrate an embodiment of a complex polarizing beamsplitter which may be used with the embodiment of FIG. 5, for example. Various display systems using various light sources can be configured using a single image generation chip (LCOS) with maximum light efficiency if both polarizations from the light sources can be directed to the same image chip. This can be accomplished by means of a polarization combining prism which separates an input beam into two polarizations, and rotates one to be oriented similarly to the other. The two halves of the input beam illuminate the two halves of an image generating chip (or other reflective optical component) as shown in FIG. 11A. A single polarization beam splitter would suffice if half the light from the light source were not used, but this allows for greater efficiency.

Using a light source similar to that of FIG. 1, one can interpose a more complex polarization beam splitter between the light source and an LCoS chip 1160 in display system 1100, resulting in creation of two output beams with the same polarization. Beam splitter 1150 splits a beam into two beams with the same polarization state. By including a half-wave plate 1140 at an interface within the beam splitter 1150, one of the beams (the beam passing through the half-wave plate) is polarization rotated to the same state as the other (the beam passing through the mirror and around the half-wave plate) so each beam illuminates a different half of the LCoS chip with the same polarization. Note that the half-wave plate 1140 extends only through half of the interface with beam splitter 1150—thus it only interacts with one of the beams and has no effect on the other beam. The result is two beams directed at the LCoS chip 1160 with the same polarization. The resulting output beams 1180 are then directed at a screen, potentially through further projection optics. Note that LCoS chip 1160 may need to have twice the width of the LCoS chips 160 of FIG. 1, to accommodate the two beams from beam splitter 1150. Alternatively, a lower resolution image can be produced using half of one LCoS chip 160 for each beam.

FIG. 11B further illustrates the complex polarization beam splitter 1150. Prism 1155 receives light from a light source, and splits it into two light beams having orthogonal polarization states. Mirror 1165 reflects one beam with a first polarization state upward (in this perspective). Half wave plate 1140 rotates the polarization state of the other beam from a second polarization state to the first polarization state. As a result, two beams are transmitted through prism 1175 to a reflective optical component, such as LCoS 1160, with each having the same polarization state. Note that whether the first or second polarization state is chosen is not material. The reflective component then reflects light back (potentially modulated for an image) through prism 1175, which reflects the light from the reflective optical component 1160 as output light 1180.

Further consideration of various embodiments may also be illustrative. In an embodiment, a system is provided. The system includes a housing. The system further includes a first LCoS assembly coupled to the housing. The system also includes a second LCoS assembly coupled to the housing. The system further includes a third LCoS assembly coupled to the housing. Additionally, the system includes a first beam splitter and a second beam splitter both coupled to the housing. The first beam splitter is arranged to split incoming light between the first LCoS assembly and the second beam splitter. The second beam splitter is arranged to split incoming light between the second LCoS assembly and the third LCoS assembly. The system also includes a first beam recombiner and a second beam recombiner both coupled to the housing. The first beam recombiner is arranged to receive light from the first LCoS assembly and the second LCoS assembly. The second beam recombiner is arranged to receive light from the first beam recombiner and from the third LCoS assembly. The system also includes a first light source to provide incoming light to the first beam splitter. The system further includes an output optics element coupled to the housing and arranged to receive light from the second beam recombiner and to focus an output light source.

In some embodiments, the first LCoS assembly, the second LCoS assembly and the third LCoS assembly each include a polarization beam splitter coupled optically to a first LCoS chip and a second LCoS chip. The first LCoS chip is to receive and modulate light of a first polarization and the second LCoS chip is to receive and modulate light of a second polarization.

In some embodiments, the first beam splitter is mounted with the first LCoS assembly on a first mounting component which, when translated along an axis, causes the first LCoS assembly and the first beam splitter to translate along the axis therewith.

In such embodiments, the second beam splitter may be mounted with the second LCoS assembly on a second mounting component which, when translated along an axis, causes the second LCoS assembly and the second beam splitter to translate along the axis therewith.

In some embodiments, each of the first, second and third LCoS assemblies further include a first heat sink mounted on the first LCoS chip and a second heat sink mounted on the second LCoS chip. Moreover, in some embodiments, an IR/UV rejection optical component disposed between the light source and the first beam splitter. Additionally, in some embodiments, a fan is coupled to the housing. Moreover, in some embodiments, a coolant circulation system coupled to the housing and coupled to the heat sinks of the first, second and third LCoS assemblies. Also, in some embodiments, the fan is arranged in the housing to circulate air in a path distinct from an optical path of the first, second and third LCoS assemblies.

Additionally, in some embodiments, the system includes a processor and a memory coupled to the processor. Moreover, the system may include a bus coupled to the memory and the processor. Also, the system may include a communications path between the processor and each of the first and second LCoS chips of the first, second and third LCoS assemblies. Likewise, the system may include an interface coupled to the processor, the interface to receive data from a source external to the system.

The system, in various embodiments, may use a variety of light sources. In some embodiments, the first light source is a lamp.

In some embodiments, the first light source is a plurality of LEDs. In some embodiments, the first light source is a plurality of laser diodes. Moreover, in some embodiments, the first beam recombiner is a dichroic mirror and the second beam recombiner is a dichroic mirror.

In another embodiment, a system is provided. The system includes a housing. The system also includes a first LCoS assembly coupled to the housing. The first LCoS assembly includes a polarization beam splitter coupled optically to a first LCoS chip and a second LCoS chip. The first LCoS chip is to receive and modulate light of a first polarization and the second LCoS chip is to receive and modulate light of a second polarization. The first LCoS assembly further includes a first heat sink mounted on the first LCoS chip and a second heat sink mounted on the second LCoS chip.

The system may further include a second LCoS assembly coupled to the housing. The second LCoS assembly includes a polarization beam splitter coupled optically to a first LCoS chip and a second LCoS chip. The first LCoS chip is to receive and modulate light of a first polarization and the second LCoS chip is to receive and modulate light of a second polarization. The second LCoS assembly further includes a first heat sink mounted on the first LCoS chip and a second heat sink mounted on the second LCoS chip. The system may also include a third LCoS assembly coupled to the housing. The third LCoS assembly includes a polarization beam splitter coupled optically to a first LCoS chip and a second LCoS chip. The first LCoS chip is to receive and modulate light of a first polarization and the second LCoS chip is to receive and modulate light of a second polarization. The third LCoS assembly further includes a first heat sink mounted on the first LCoS chip and a second heat sink mounted on the second LCoS chip;

The system may also include a first beam splitter and a second beam splitter both coupled to the housing. The first beam splitter is arranged to split incoming light between the first LCoS assembly and the second beam splitter. The second beam splitter is arranged to split incoming light between the second LCoS assembly and the third LCoS assembly. A first dichroic mirror and a second dichroic mirror both are also coupled to the housing in some embodiments. The first dichroic mirror is arranged to receive light from the first LCoS assembly and the second LCoS assembly, and the second dichroic mirror is arranged to receive light from the first beam recombiner and from the third LCoS assembly. The system may further include a first light source to provide incoming light to the first beam splitter. The system may also include an output optics element coupled to the housing and arranged to receive light from the second dichroic mirror and to focus an output light source.

The system further includes a processor and a memory coupled to the processor. The system also includes a bus coupled to the memory and the processor. The system further includes a communications path between the processor and each of the first and second LCoS chips of the first, second and third LCoS assemblies.

The system may further include a user interface coupled to the processor. The system may also include an IR/UV rejection optical component disposed between the light source and the first beam splitter. The system may further include a coolant circulation system coupled to the housing and coupled to the heat sinks of the first, second and third LCoS assemblies. The system may also include an interface coupled to the processor, the interface to receive data from a source external to the system.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1. A system comprising:
A housing;
A first LCoS assembly coupled to the housing;
A second LCoS assembly coupled to the housing;
A third LCoS assembly coupled to the housing;
A first beam splitter and a second beam splitter both coupled to the housing, the first beam splitter arranged to split incoming light between the first LCoS assembly and the second beam splitter, the second beam splitter arranged to split incoming light between the second LCoS assembly and the third LCoS assembly;
A first beam recombiner and a second beam recombiner both coupled to the housing, the first beam recombiner arranged to receive light from the first LCoS assembly and the second LCoS assembly, the second beam recombiner arranged to receive light from the first beam recombiner and from the third LCoS assembly;
A first light source to provide incoming light to the first beam splitter;
And
An output optics element coupled to the housing and arranged to receive light from the second beam recombiner and to focus an output light source.

2. The system of claim 1, wherein:
The first LCoS assembly, the second LCoS assembly and the third LCoS assembly each include a polarization beam splitter coupled optically to a first LCoS chip and a second LCoS chip, the first LCoS chip to receive and modulate light of a first polarization and the second LCoS chip to receive and modulate light of a second polarization.

3. The system of claim 2, wherein:
The first beam splitter is mounted with the first LCoS assembly on a first mounting component which, when translated along an axis, causes the first LCoS assembly and the first beam splitter to translate along the axis therewith;
The second beam splitter is mounted with the second LCoS assembly on a second mounting component which, when translated along an axis, causes the second LCoS assembly and the second beam splitter to translate along the axis therewith.

4. The system of claim 2, wherein:
Each of the first, second and third LCoS assemblies further include a first heat sink mounted on the first LCoS chip and a second heat sink mounted on the second LCoS chip.

5. The system of claim 2, further comprising:
An IR/UV rejection optical component disposed between the light source and the first beam splitter.

6. The system of claim 4, further comprising:
A fan coupled to the housing.

7. The system of claim 4, further comprising:
A coolant circulation system coupled to the housing and coupled to the heat sinks of the first, second and third LCoS assemblies.

8. The system of claim 4, wherein:
The fan is arranged in the housing to circulate air in a path distinct from an optical path of the first, second and third LCoS assemblies.

9. The system of claim 2, further comprising:
A processor;
A memory coupled to the processor;
A bus coupled to the memory and the processor;
And
A communications path between the processor and each of the first and second LCoS chips of the first, second and third LCoS assemblies.

10. The system of claim 9, further comprising:
An interface coupled to the processor, the interface to receive data from a source external to the system.

11. The system of claim 1, wherein:
The first light source is a lamp.

12. The system of claim 1, wherein:
The first light source is a plurality of LEDs.

13. The system of claim 1, wherein:
The first light source is a plurality of laser diodes.

14. The system of claim 1, wherein:
The first beam recombiner is a dichroic mirror and the second beam recombiner is a dichroic mirror.

15. A system comprising:
A housing;
A first LCoS assembly coupled to the housing, the first LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the first LCoS assembly further includes a first heat sink mounted on the first LCoS chip and a second heat sink mounted on the second LCoS chip;
A second LCoS assembly coupled to the housing, the second LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the second LCoS assembly further includes a first heat sink mounted on the first LCoS chip and a second heat sink mounted on the second LCoS chip;
A third LCoS assembly coupled to the housing, the third LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the third LCoS assembly further includes a first heat sink mounted on the first LCoS chip and a second heat sink mounted on the second LCoS chip;
A first beam splitter and a second beam splitter both coupled to the housing, the first beam splitter arranged to split incoming light between the first LCoS assembly and the second beam splitter, the second beam splitter arranged to split incoming light between the second LCoS assembly and the third LCoS assembly;
A first dichroic mirror and a second dichroic mirror both coupled to the housing, the first dichroic mirror arranged to receive light from the first LCoS assembly and the second LCoS assembly, the second dichroic mirror arranged to receive light from the first beam recombiner and from the third LCoS assembly;
A first light source to provide incoming light to the first beam splitter;
An output optics element coupled to the housing and arranged to receive light from the second dichroic mirror and to focus an output light source;
A processor;
A memory coupled to the processor;
A bus coupled to the memory and the processor;
And
A communications path between the processor and each of the first and second LCoS chips of the first, second and third LCoS assemblies.

16. The system of claim 15, further comprising:
A user interface coupled to the processor.

17. The system of claim 15, further comprising:
An IR/UV rejection optical component disposed between the light source and the first beam splitter.

18. The system of claim 15, further comprising:
A coolant circulation system coupled to the housing and coupled to the heat sinks of the first, second and third LCoS assemblies.

19. The system of claim 15, further comprising:
An interface coupled to the processor, the interface to receive data from a source external to the system.

20. A system comprising:
A housing;
A first LCoS assembly coupled to the housing, the first LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the first LCoS assembly further includes a first heat sink mounted on the first LCoS chip and a second heat sink mounted on the second LCoS chip;
A second LCoS assembly coupled to the housing, the second LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the second LCoS assembly further includes a first heat sink mounted on the first LCoS chip and a second heat sink mounted on the second LCoS chip;
A third LCoS assembly coupled to the housing, the third LCoS assembly includes a polarization beam splitter coupled optically to a first LCoS chip and a second LCoS chip, the first LCoS chip to receive and modulate light of a first polarization and the second LCoS chip to receive and modulate light of a second polarization, and the third LCoS assembly further includes a first heat sink mounted on the first LCoS chip and a second heat sink mounted on the second LCoS chip;
A coolant circulation system coupled to the housing and coupled to the heat sinks of the first, second and third LCoS assemblies;
A first beam splitter and a second beam splitter both coupled to the housing, the first beam splitter arranged to split incoming light between the first LCoS assembly and the second beam splitter, the second beam splitter arranged to split incoming light between the second LCoS assembly and the third LCoS assembly;
An IR/UV rejection optical component disposed between the light source and the first beam splitter;
A first dichroic mirror and a second dichroic mirror both coupled to the housing, the first dichroic mirror arranged to receive light from the first LCoS assembly and the second LCoS assembly, the second dichroic mirror arranged to receive light from the first beam recombiner and from the third LCoS assembly;
A first light source to provide incoming light to the first beam splitter;
An output optics element coupled to the housing and arranged to receive light from the second dichroic mirror and to focus an output light source;
A processor;
A memory coupled to the processor;
A bus coupled to the memory and the processor;
A communications path between the processor and each of the first and second LCoS chips of the first, second and third LCoS assemblies;
And
An interface coupled to the processor, the interface to receive data from a source external to the system.
